(19) United States
(12) Patent Application Publication
(10) Pub. No.: US 2025/0236975 A1
(43) Pub. Date: Jul. 24, 2025

(54) CO2 CONVERSION TO ETHYLENE USING Zn-Cu GAS DIFFUSION ELECTRODES

(71) Applicant: KING FAHD UNIVERSITY OF PETROLEUM AND MINERALS, Dhahran (SA)

(72) Inventors: Munzir Hamedelniel Mohamed SULIMAN, Dhahran (SA); Muhammad USMAN, Dhahran (SA)

(73) Assignee: KING FAHD UNIVERSITY OF PETROLEUM AND MINERALS, Dhahran (SA)

(21) Appl. No.: 18/421,486

(22) Filed: Jan. 24, 2024

(51) Int. Cl. C25B 11/077; B01D 53/32; B01D 53/86; C01G 9/00; C25B 3/03; C25B 3/26; C25B 11/032

(52) U.S. Cl. CPC C25B 11/077; B01D 53/326; B01D 53/8671; C01G 9/00; C25B 3/03; C25B 3/26; C25B 11/032; B01D 2255/20761; B01D 2255/20792; B01D 2255/40; B01D 2255/806; B01D 2255/9202; B01D 2257/504; C01P 2002/72; C01P 2002/85; C01P 2002/90; C01P 2004/03; C01P 2004/04; C01P 2004/64; C01P 2006/40

(57) ABSTRACT

A method of making an electrode including dissolving a copper (Cu) salt and benzene-1,3,5-tricarboxylate in a solvent and heating to a temperature of 60° C. to 100° C. to form a framework. Further, the method includes mixing a zinc (Zn) salt and the framework to form a zinc-doped framework and heating the zinc-doped framework to a temperature of 300° C. to 600° C. under air to form ZnCuO nanoparticles. Furthermore, the method includes mixing the ZnCuO nanoparticles, a binding compound, and a conductive carbon compound in a solvent to form a suspension and spraying the suspension onto a substrate with a spray gun using air pressure to form the electrode. The ZnCuO nanoparticles have a spherical shape with an average size of less than 100 nanometers (nm).

### CROSS REFERENCE TO RELATED APPLICATION

The present application is related to U.S. application Ser. No. 18/494,813 having a filing date of Oct. 26, 2023, which is incorporated herein by reference in its entirety.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to an electrode, more particularly directed to a bimetallic zinc/copper oxides derived from HKUST-1 metal-organic framework-based electrode for electrocatalytic reduction of carbon dioxide (CO₂) to ethylene (C₂H₄).

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Burning fossil fuels produces greenhouse gases such as CO₂, nitric oxide (NO), and methane (CH₄), which negatively impact the environment. Therefore, CO₂ reduction is a positive approach for a robust environmental value-added chemical production and energy storage infrastructure. The electrochemical reduction of CO₂ requires improvements in regard to control of product selectivity, the enhancement of product conversion rate, and the minimal needed overpotential. Typically, this process includes numerous proton and electron transfers, thus producing various products, each with several likely reaction intermediates. The products produced in CO₂ reduction are typically separated into two groups: 1) C1 products containing 1 carbon atom such as carbon monoxide, methanol, methane, and formic acid and 2) C2 products containing 2 carbon atoms such as ethylene and ethanol. C₂H₄ is a fundamental component in the petrochemical industry. Traditionally, it is derived from fossil fuels and is closely linked to environmental issues due to carbon-intensive procedures in its production. Therefore, there is a need to produce ethylene that is environmentally conscious. This complexity poses significant drawbacks in the characterization of molecular-level reaction mechanisms, which are demanding in the design of selective, effective electrodes and stable electro-catalysts.

Materials employed in electrochemical reduction should be available in large quantities with significant efficiency while preserving low costs to ensure their economic viability. Furthermore, favorable properties include high CO₂ adsorption capacity, efficient charge transfer kinetics, and the ability to suppress competing reactions. The catalysts should exhibit long-term stability, allowing continuous CO₂ reduction under various operating conditions. To date, different electrode materials and designs have been investigated for the electrochemical reduction of CO₂, with materials such as metal nanoparticles, metal-organic frameworks, and single-atom catalysts.

Copper (Cu)-based catalysts have emerged as promising candidates for CO₂ electroreduction due to their high activity and selectivity towards producing C₂⁺ products. The presence of copper oxide species on the catalyst surface helps facilitate the desired chemical transformations. However, challenges such as catalyst stability and competing hydrogen evolution reactions still need to be addressed to maximize the efficiency of Cu-based catalysts for CO₂ conversion.

Zinc (Zn) is also a potential electrocatalyst for CO₂ reduction. Zinc-based catalysts offer advantages such as low cost, earth abundance, and tunable catalytic properties. Zinc promotes electrochemical CO₂ reduction to carbon monoxide (CO). Active sites on the zinc catalyst surface facilitate the adsorption of CO₂, leading to the subsequent reduction of CO₂ to CO. Zinc-based catalysts possess electrochemical stability, which is attributed to the formation of protective surface layers or oxides that prevent the dissolution or deterioration of the catalyst.

Nonetheless, the conventional methods generally entail extreme energy intake and lengthy reaction times (>24 hours with low production rates). Accordingly, an object of the present disclosure is to develop an electrode for CO₂ reduction, that overcomes the drawbacks of the art.

### SUMMARY

In an exemplary embodiment, a method of making an electrode is described. The method includes dissolving a copper (Cu) salt and benzene-1,3,5-tricarboxylate in a solvent and heating to a temperature of 60° C. to 100° C. to form a framework. Further, the method includes mixing a zinc (Zn) salt and the framework to form a zinc doped framework and heating the zinc doped framework to a temperature of 300° C. to 600° C. under air to form ZnCuO nanoparticles. Furthermore, the method includes mixing the ZnCuO nanoparticles, a binding compound, and a conductive carbon compound in a solvent to form a suspension and spraying the suspension onto a substrate with a spray gun using air pressure to form the electrode. Moreover, the ZnCuO nanoparticles have a spherical shape with an average size of less than 100 nanometers (nm).

In some embodiments, the ZnCuO nanoparticles have an average size of 10 nm to 60 nanometers (nm).

In some embodiments, the ZnCuO nanoparticles include 5 wt % to 50 wt % Zn, relative to a total weight of Zn and Cu in the ZnCuO nanoparticles.

In some embodiments, the ZnCuO nanoparticles are aggregated, forming an interconnected structure.

In some embodiments, the ZnCuO nanoparticles includes CuO and ZnO, and the CuO has a monoclinic crystal structure, whereas the ZnO has a hexagonal crystal structure.

In some embodiments, the CuO and ZnO are uniformly dispersed in the ZnCuO nanoparticles.

In some embodiments, the method further includes sonicating the suspension for at least 10 minutes prior to the spraying.

In some embodiments, in the mixing of the zinc salt, Zn is homogeneously dispersed in pores of the framework without distortion of the framework.

In some embodiments, the heating is to about 500° C.

In some embodiments, the copper salt is selected from the group including copper (II) chloride, copper (II) sulfate, copper (II) nitrate, copper (II) acetate, copper (II) bromide, and hydrates thereof.

In some embodiments, the zinc salt is selected from the group including zinc (II) chloride, zinc (II) sulfate, zinc (II) nitrate, zinc (II) acetate, zinc (II) bromide, and hydrates thereof.

In some embodiments, the conductive carbon compound is at least one selected from the group, including graphite, activated carbon, reduced graphene oxide, carbon nanotubes, carbon nanofibers, and carbon black.

In some embodiments, the binding compound is a fluorinated polymer.

In some embodiments, the substrate is made from at least one material selected from the group, including conductive carbon, stainless steel, aluminum (Al), nickel (Ni), Cu, platinum (Pt), Zn, tungsten (W), and titanium (Ti).

In some embodiments, the suspension includes 70 wt. % to 90 wt. % of the ZnCuO nanoparticles and 10 wt. % to 30 wt. % of the conductive carbon compound, based on a total weight of the ZnCuO nanoparticles and the conductive carbon compound.

In another exemplary embodiment, the method includes applying a potential of −0.1 V to −2.0 V vs. reversible hydrogen electrode (RHE) to an electrochemical cell and the electrochemical cell is at least partially submerged in an aqueous solution including carbon dioxide. Further, on applying the potential, the carbon dioxide is reduced to a conversion product. Furthermore, the electrochemical cell includes the electrode and a counter electrode.

In some embodiments, the conversion product is selected from ethylene, methane, formic acid, and carbon monoxide.

In some embodiments, the aqueous solution further includes a base selected from at least one of sodium bicarbonate and potassium bicarbonate.

In some embodiments, the electrode prepared by the method of present disclosure has a faradic efficiency for reducing carbon dioxide to ethylene of 40% to 50%.

In some embodiments, the aqueous solution is saturated with the carbon dioxide.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a method flowchart for making an electrode, according to certain embodiments.

FIG. 2 is a graph depicting an X-ray diffraction (XRD) pattern of bimetallic zinc and copper oxide (ZnCuO) synthesized at 500° C., according to certain embodiments.

FIG. 3A is a graph depicting an X-ray photoelectron spectroscopy (XPS) survey scan of ZnCuO, according to certain embodiments.

FIG. 3B is a graph depicting an XPS spectrum of Cu 2p, according to certain embodiments.

FIG. 3C is a graph depicting an XPS spectrum of Zn 2p, according to certain embodiments.

FIG. 3D is a graph depicting an XPS spectrum of O 1s, according to certain embodiments.

FIG. 4A is a scanning electron microscopy (SEM) image of ZnCuO, according to certain embodiments.

FIG. 4B is a transmission electron microscopy (TEM) image of ZnCuO, according to certain embodiments.

FIG. 4C is a high-resolution transmission electron microscopy (HRTEM) image of ZnCuO, according to certain embodiments.

FIG. 5A is an energy-dispersive X-ray (EDX) image showing the presence of Cu in an elemental mapping of ZnCuO, according to certain embodiments.

FIG. 5B is an EDX image showing the presence of Zn in the elemental mapping of ZnCuO, according to certain embodiments.

FIG. 5C is an EDX image showing the presence of O in the elemental mapping of ZnCuO, according to certain embodiments.

FIG. 6 is a graph depicting a voltammogram obtained from comparative linear sweep voltammetry (LSV) of ZnCuO in a hydrogen fuel cell (H-Cell) and flow cell, according to certain embodiments.

FIG. 7A is a schematic diagram of the flow cell and relevant components included in the flow, according to certain embodiments.

FIG. 7B is a graph depicting faradaic efficiency percentage (FE %) of ZnCuO at a plurality of applied potentials, according to certain embodiments.

FIG. 7C is a graph depicting FE % of ethylene (C₂H₄), using ZnCuO, with obtained current density, according to certain embodiments.

FIG. 7D is a graph depicting the long-term stability of ZnCuO using a flow cell and 1 molar (M) potassium hydroxide (KOH), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, “particle size” may be thought of as the length or longest dimension of a particle.

As used herein, the term ‘sonication’ refers to the process in which sound waves are used to agitate particles in a solution.

As used herein, the term “electrode” refers to an electrical conductor used to contact a non-metallic part of a circuit e.g., a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of either generating electrical energy from chemical reactions or using electrical energy to cause chemical reactions.

As used herein, the term “overpotential” “refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically expected to drive a reaction. The quantity of overpotential is specific to each cell design and varies across cells and operational conditions, even for the same reaction. Overpotential is experimentally measured by determining the potential at which a given current density is reached.

As used herein “metal-organic frameworks” or MOFs are compounds having a lattice structure made from (i) a cluster of metal ions as vertices (“cornerstones”) (“secondary building units” or SBUs) which are metal-based inorganic groups, for example metal oxides and/or hydroxides, linked together by (ii) organic linkers. The linkers are usually at least bidentate ligands which coordinate to the metal-based inorganic groups via functional groups such as carboxylates and/or amines. MOFs are considered coordination polymers made up of (i) the metal ion clusters and (ii) linker building blocks.

As used herein, the term ‘faradaic efficiency (FE)’ refers to the overall selectivity of an electrochemical process and is defined as the amount (moles) of collected product relative to the amount that can be produced from the total charge passed, expressed as a fraction or a percent.

The present disclosure is intended to include all hydration states of a given compound or formula, unless otherwise noted or when heating a material.

Aspects of the present disclosure are directed towards an electrode including bimetallic zinc/copper oxides, derived from a metal-organic framework. The electrodes perform electrocatalytic reduction of carbon dioxide (CO₂) to ethylene and other environmentally friendly compounds.

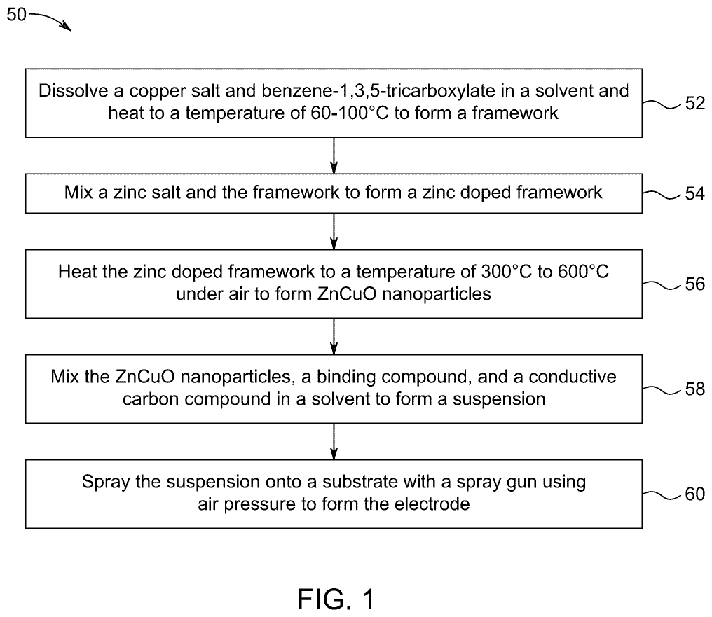

FIG. 1 illustrates a flow chart of method 50 for making an electrode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dissolving a copper salt and benzene-1,3,5-tricarboxylate (BTC) in a solvent and heating to a temperature of 60-100° C. to form a framework. In some embodiments, benzene-1,3,5-tricarboxylate is replaced by any aromatic compound substituted with at least 2 carboxyl groups, preferably 2-4, or 3 carboxyl groups. For example, benzene, naphthalene, anthracene, toluene substituted with at least 2 carboxyl groups. The copper salt may be copper chloride (CuCl₂), however, in some embodiments, the copper salt is selected from a group including, but may not be limited to, copper (II) sulfate, copper (II) nitrate, copper (II) acetate, copper (II) bromide, and hydrates thereof. The solvent may be an organic solvent or an inorganic solvent. Suitable examples of the organic solvent include tetrahydrofuran, ethyl acetate, dimethylformamide (DMF), acetonitrile, acetone, dimethyl sulfoxide, nitromethane, propylene carbonate, ethanol, formic acid, n-butanol, methanol, benzene, cyclohexane, ethyl acetate, dichloromethane, toluene, and diethyl ether, or any combination thereof. In some embodiments, the solvent is water. In some embodiments, the solvent is a mixture of organic and inorganic solvents. In a preferred embodiment, the solvent includes a mixture of DMF, ethanol, and water. The v/v ratio of DMF to ethanol is in a range of 1:1 to 1:10, preferably 1:1 to 1:5, preferably 1:1 to 1:4, preferably 1:1 to 1:3, preferably 1:1 to 1:2, preferably 1:1. The v/v/v ratio of DMF to ethanol to water is 1:1:1. In an embodiment, the heating is carried to a temperature of 60° C. to 100° C., preferably 65-95° C., preferably 70-90° C., preferably 75-85° C., preferably 80° C. to form a framework for 18-30 hours, preferably 20-28 hours, preferably 22 to 26 hours, preferably 24 hours to form the framework. In a specific embodiment, the metal-organic framework is synthesized by dissolving copper chloride and BTC in a solvent (including a mixture of DMF, ethanol, and water) and heating to a temperature of 80° C. to form the framework.

In some embodiments, the framework is a metal-organic framework. In some embodiments, the metal-organic framework is HKUST-1. The HKUST-1 framework is built up of dimeric metal units, which are connected by benzene-1,3,5-tricarboxylate linker molecules. A paddlewheel unit is a structural motif to describe the coordination environment of the SBU of the HKUST-1 structure. The paddlewheel is built up of four benzene-1,3,5-tricarboxylate linkers molecules, which bridge two metal centers. One water molecule is coordinated to each of the two metal centers at the axial position of the paddlewheel unit in the hydrated state, which is usually found if the material is handled in air. After an activation process (heating, vacuum), these water molecules can be removed (dehydrated state), and the coordination site at the metal atoms is left unoccupied. This unoccupied coordination site is called a coordinatively unsaturated site (CUS) and can be accessed by other molecules. In this step of the synthesis, the metal center is Cu²⁺.

At step 54, the method 50 includes mixing a zinc salt and the framework to form a zinc doped framework. In some embodiments, the zinc salt is selected from the group consisting of zinc (II) chloride, zinc (II) sulfate, zinc (II) nitrate, zinc (II) acetate, zinc (II) bromide, and hydrates thereof. In a specific embodiment, the zinc salt is zinc (II) acetate [Zn(Ac)₂]. The mixing may be carried out manually or with the help of a stirrer. The weight ratio of the zinc salt to the framework is in a range of 1:1 to 1:10, preferably 1:2 to 1:9, preferably 1:3 to 1:8, preferably 1:4 to 1:7, preferably 1:5 to 1:6, preferably 1:5. On mixing the zinc salt, Zn is homogeneously dispersed in pores of the framework without distortion of the framework. For complete dispersion of the Zn⁺² within the pores of the framework, a suspension including the zinc salt, an organic solvent (ethanol), and the framework are sonicated for 5-15 minutes (min), preferably 6-14 min, preferably 7-13 min, preferably 8-12 min, preferably 9-11 min, and more preferably 10 min to form the zinc doped framework.

At step 56, the method 50 includes heating the zinc-doped framework to a temperature of 300° C.-600° C., preferably 350-550° C., and preferably 400-500° C., under air to form ZnCuO nanoparticles. In a preferred embodiment, the zinc-doped framework is heated to a temperature of 500° C. under air to form ZnCuO nanoparticles. The heating can be done by using heating appliances such as hot plates, heating mantles ovens, microwaves, autoclaves, tapes, oil baths, salt baths, sand baths, air baths, hot-tube furnaces, and hot-air guns. In some embodiments, the heating is carried out in a furnace at a heating rate of 1-5 degrees Celsius per minute (° C. min⁻¹), preferably 1, preferably 2, preferably 3, preferably 4, preferably 5° C. min⁻¹, under air. In a preferred embodiment, the heating is carried out in a furnace at a heating rate of 5° C. min⁻¹, under air, until the temperature of the furnace reaches a temperature of about 500° C. to form ZnCuO nanoparticles.

The ZnCuO nanoparticles may exist in various morphological shapes, such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof. In a specific embodiment, the ZnCuO nanoparticles have a spherical shape with an average size of less than 100 nm. In some embodiments, the ZnCuO nanoparticles have an average size of 10-60 nanometer (nm), preferably 15-55 nm, preferably 20-50 nm, preferably 25-45 nm, and preferably 30-40 nm. In some embodiments, the ZnCuO nanoparticles are aggregated, forming an interconnected structure. In other words, there are no individual islands of ZnCuO nanoparticles in the resulting electrode but rather the nanoparticles are connected.

The ZnCuO nanoparticles include Cu, C, Zn, and O. In some embodiments, the ZnCuO nanoparticles include 30-40 wt. %, preferably 31-39 wt. %, preferably 32-38 wt. %, preferably 33-37.5 wt. %, preferably 34-37.1 wt. %, preferably 37.1 wt. % Cu; 30-40 wt. %, preferably 32-38 wt. %, preferably 33-37 wt. %, preferably 34-36 wt. %, preferably 35-36 wt. % C; 10-20 wt. %, preferably 11-19 wt. %, preferably 12-18 wt. %, preferably 13-17 wt. %, preferably 14-16 wt. %, preferably 14.6 wt. % Zn; and 10-20 wt. %, preferably 11-19 wt. %, preferably 12-18 wt. %, preferably 13-17 wt. %, preferably 13 wt. % O.

In some embodiments, the ZnCuO nanoparticles include 5-50 wt % Zn, preferably 10-45 wt % Zn, 15-40 wt % Zn, 20-35 wt % Zn, or 25-30 wt % Zn relative to a total weight of Zn and Cu in the ZnCuO nanoparticles. In some embodiments, the ZnCuO nanoparticles include CuO and ZnO. In some embodiments, the CuO and ZnO are uniformly dispersed in the ZnCuO nanoparticles. The CuO has a monoclinic or cubic crystal structure, preferably monoclinic. The ZnO has a hexagonal, cubic or monoclinic crystal structure, preferably hexagonal. In some embodiments, the ZnCuO nanoparticles include at least one of Cu(0), Cu(I), and Cu(II), and at least one of Zn(0) and Zn(II).

At step 58, the method 50 includes mixing the ZnCuO nanoparticles, a binding compound, and a conductive carbon compound in a solvent to form a suspension. The mixing may be carried out manually or with the help of a stirrer. In some embodiments, the conductive carbon compound is at least one selected from the group consisting of graphite, activated carbon, reduced graphene oxide, carbon nanotubes, carbon nanofibers, and carbon black. The binding compound is a fluorinated polymer. Suitable examples of fluorinated polymer include polytetrafluoroethylene (PTFE), polyethylene chlorotrifluoroethylene (ECTFE), polyethylene tetrafluoroethylene (ETFE), fluorinated-ethylene-propylene (FEP), perfluoro-alkoxy (PFA), polychlorotrifluoroethylene (PCTFE), polyvinylidene-fluoride (PVDF), sulfonated tetrafluoroethylene (Nafion®), and combinations thereof. In a preferred embodiment, the fluorinated polymer is Nafion. Suitable examples of the organic solvent include tetrahydrofuran, ethyl acetate, dimethylformamide (DMF), acetonitrile, acetone, isopropanol, dimethyl sulfoxide, nitromethane, propylene carbonate, ethanol, formic acid, n-butanol, methanol, benzene, cyclohexane, ethyl acetate, dichloromethane, toluene, and diethyl ether, or any combination thereof. In a preferred embodiment, the solvent is isopropanol.

The suspension includes 70-90 wt. %, preferably 71-89 wt. %, preferably 72-88 wt. %, preferably 73-87 wt. %, preferably 74-86 wt. %, preferably 75-85 wt. %, preferably 76-84 wt. %, preferably 77-83 wt. %, preferably 78-82 wt. %, preferably 79-81 wt. % or about 80 wt. % of the ZnCuO nanoparticles and 10-30 wt. % of the conductive carbon compound, preferably 11-29 wt. %, preferably 12-28 wt. %, preferably 13-27 wt. %, preferably 14-26 wt. %, preferably 15-25 wt. %, preferably 16-24 wt. %, preferably 17-23 wt. %, preferably 18-22 wt. %, preferably 19-21 wt. %, or about 20 wt. % of the conductive carbon compound, based on the total weight of the ZnCuO nanoparticles and the conductive carbon compound.

At step 60, the method 50 includes spraying the suspension onto a substrate with a spray gun using air pressure, to form the electrode. The spraying may occur 1-10 times, preferably 2-9, 3-8, 4-7, or 5-6 times in order to increase a thickness of the layers on the substrate. Preferably the layer of the sprayed suspension on the substrate after drying has a thickness of 0.01 to 10 μm, preferably 0.5-5 μm, or about 1 μm. In a preferred embodiment, the suspension is sonicated for at least 10 min, preferably 11 min, preferably 12 min, preferably 13 min, preferably 14 min, preferably 15 min, preferably 16 min, preferably 17 min, preferably 18 min, preferably 19 min, preferably 20 min, preferably 21 min, preferably 22 min, preferably 23 min, preferably 24 min, and preferably 25 min prior to the spraying. In a preferred embodiment, the suspension is sonicated for 20 min.

The substrate may have any suitable shape, as would be known to one of skill in the art. In some embodiments, the substrate is made from at least one material selected from the group, including conductive carbon, stainless steel, aluminum (Al), nickel (Ni), Cu, platinum (Pt), Zn, tungsten (W), and titanium (Ti). In a preferred embodiment, the substrate is a gas diffusion layer (GDL). GDLs are thin porous sheets that may be included in various types of fuel cells, including Proton Exchange Membrane (PEM), Direct Methanol (DMFC) and Phosphoric Acid (PAFC) stacks as well as in other electrochemical devices such as electrolyzers. In fuel cells, the GDL provides high electrical and thermal conductivity and chemical/corrosion resistance, in addition to controlling the proper flow of reactant gases (such as carbon dioxide) and managing the water transport out of the membrane electrode assembly (MEA). This layer should also have controlled compressibility to support the external forces from the assembly, and not deform into the bi-component plate channels to restrict flow. Examples of GDLs include but are not limited to carbon cloth, carbon paper, and nickel foam.

In an embodiment, the method further includes applying a potential of −0.1 to −2.0 V, preferably −0.2 to −1.8 V, preferably −0.4 to −1.6 V, preferably −0.6 to −1.4 V, preferably −0.8 to −1.2 V, or about −1 V, vs RHE to an electrochemical cell. The electrochemical cell includes a working electrode, a counter electrode, and optionally a reference electrode. The high stability of the electrode potential is usually reached by employing a redox system with constant (buffered or saturated) concentrations of each relevant species of the redox reaction. In some embodiments, the working electrode is the above-described electrode based on ZnCuO nanoparticles.

A reference electrode may enable a potentiostat to deliver a stable voltage to the working or counter electrodes. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is present and is Ag/AgCl.

In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The material of the counter electrode should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode. In a preferred embodiment, the counter electrode is a platinum mesh.

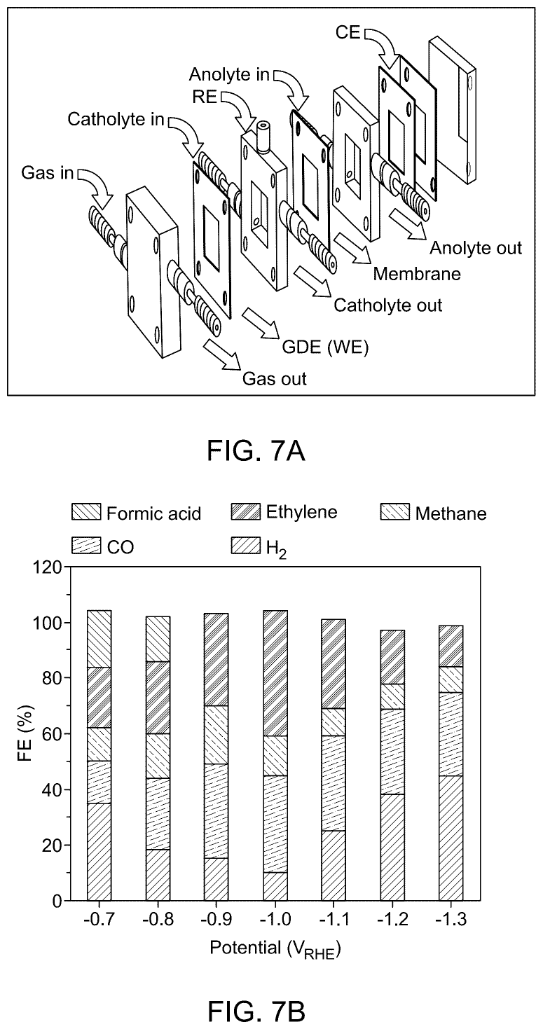

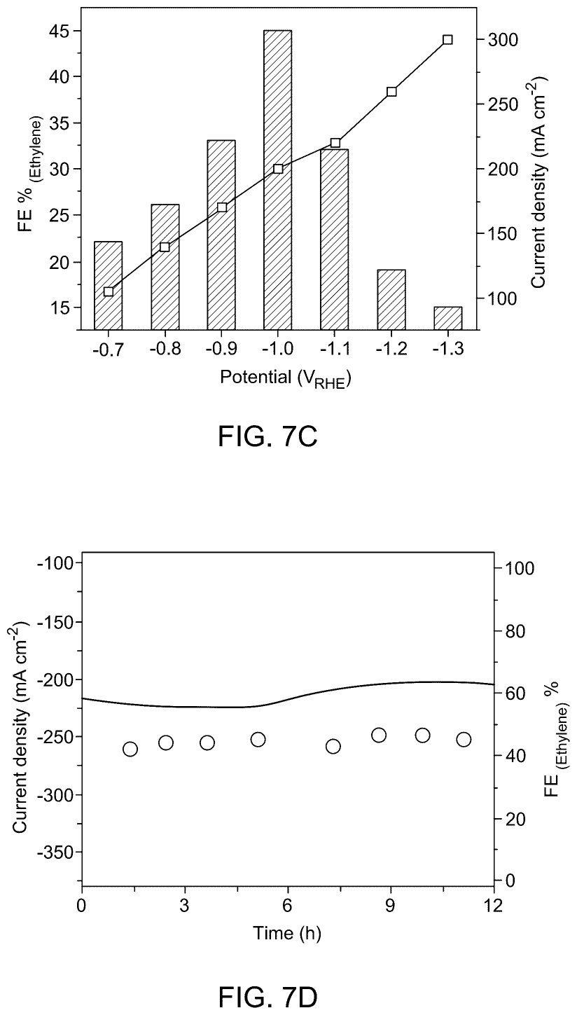

In a preferred embodiment, the electrochemical cell is a H-cell. An H-cell is a divided electrochemical cell, having of two compartments connected through a diaphragm. In a preferred embodiment, the diaphragm is a proton exchange membrane. In a more preferred embodiment, the electrochemical cell is a flow cell. The flow cell configuration includes three main components. The initial component included a dual-compartment system designed to contain electrolytes. One of the compartments was designated for the catholyte, while the other was designated for the anolyte. Both compartments contained a solution of water and an inorganic base. The second constituent of the system is the cell, including a cathode section whereby CO₂ gas is directed through one side of a gas diffusion electrode (GDE), while the catholyte is directed through the opposite side. The anode compartment is linked to the anolyte. The cellular constituents are segregated by an anionic membrane. The pump, the third component of the flow cell, plays a role in enabling the movement and circulation of the catholyte and anolyte between the compartments that house the electrolytes within the cell. The reference electrode, like the hydrogen fuel cell (H-Cell), is connected to the working electrode (GDE) on the cathode side and the counter electrode on the anode side. All the components above are interconnected with the potentiostat workstation. An embodiment of such is depicted in FIG. 7A.

In some embodiments, the aqueous solution includes CO₂, preferably it is saturated with CO₂. In some embodiments, the electrochemical cell is at least partially submerged in an aqueous solution comprising carbon dioxide, preferably 50%, preferably 60%, or more preferably at least 70%. Preferably, to maintain uniform concentrations and/or temperatures of the aqueous solution, the aqueous solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably, the stirring is done by an impeller or a magnetic stir bar.

The aqueous solution may include water and an inorganic base. The water may be tap water, distilled water, bi-distilled water, deionized water, deionized distilled water, reverse osmosis water, and/or some other water. The aqueous solution has a salt concentration of 0.05-2 molar (M), preferably 0.1-1 M, and preferably 0.25-0.5 M. In a preferred embodiment, the aqueous solution has a salt concentration of 0.5 M. In some embodiments, the salt may include ammonium bicarbonate, barium carbonate, calcium carbonate, magnesite, sodium percarbonates, and sodium carbonate. In some embodiments, the base is selected from at least one of sodium bicarbonate (NaHCO₃) and potassium bicarbonate (KHCO₃). In a preferred embodiment, the salt is KHCO₃.

In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor, which is plugged into a standard building or home electric utility line. In one embodiment, the potentiostat may connect with a reference electrode in the electrolyte solution. Preferably the potentiostat is able to supply a relatively stable voltage or potential. For example, in one embodiment, the electrochemical cell is subjected to a voltage that does not vary by more than 5%, preferably by no more than 3%, preferably by no more than 1.5% of an average value throughout the subjecting. In another embodiment, the voltage may be modulated, such as being increased or decreased linearly, being applied as pulses, or being applied with an alternating current.

Applying the potential reduces the carbon dioxide to a conversion product. The conversion product is selected from ethylene, methane, formic acid, and carbon monoxide. In a preferred embodiment, the conversion product is predominantly ethylene. The FE for reducing carbon dioxide to ethylene is about 40-50%, preferably 41-49%, preferably 42-48%, preferably 43-47%, and preferably 44-46% at −1.0 V_{RHE} and a current density of 200 mA/cm².

While not wishing to be bound to a single theory, it is thought that in the synthetic method, the matrix of HKUST-1 helps in the dispersion of Zn⁺² in the pores of the HKSUT-1 and leads to a uniform mixture of the oxides of Zn and Cu in the ZnCuO nanoparticles, along with the spraying method results in a unique morphology of the ZnCuO nanoparticles and the small size. The small size of the nanoparticles and presence of Cu—O and Zn—O bonds improves the charge transfer rate and conductivity. Further, the flow cell configuration facilitates the increased diffusion of CO₂ onto the surface of the catalyst

In some embodiments, the electrode may be used for other purposes such as but not limited to hydrogen or oxygen evolution reaction in water splitting, or it can be incorporated into a supercapacitor.

### EXAMPLES

The following examples demonstrate the synthesis and use of bimetallic zinc/copper oxides derived from Zn-HKUST-1 (Hong Kong University of Science and Technology) for carbon dioxide (CO₂) conversion to ethylene. The examples are provided solely for illustration and are not to be construed as limitations of the present disclosure, as many variations thereof are possible without departing from the spirit and scope of the present disclosure.

### Example 1: Synthesis of HKUST-1

100 milligrams (mg) of copper chloride (CuCl₂) with two units of water (2H₂O) was dissolved in 30 milliliters (mL) of 1:1:1 mixture of dimethyl formamide (DMF), ethanol, and deionized water (DI) H₂O to form a solution. Then 200 mg of benzene-1,3,5-tricarboxylate (BTC) was added to the solution. The solution was then heated at 80 degrees Celsius® C. for 24 hours (h), forming blue crystals. The blue crystals were separated by centrifugation, washed several times with DMF, DI H₂O, and ethanol, and dried under vacuum at 120° C. overnight.

### Example 2: Synthesis of Zinc Copper Oxides (ZnCuO)

mg of zinc acetate (Zn(Ac)₂) was dissolved in 20 mL ethanol, and then 100 mg of HKUST-1 (as synthesized in Example 1) was added to the Zn⁺² solution. The solution was sonicated for 10 min and stirred for 12 h, forming solid crystals. After that, the solid crystals were separated and washed three times with ethanol and dried at 50° C. under vacuum. Then, the crystals were heated at 500° C. with a 5° C./min heating rate for 5 h to produce ZnCuO nanoparticles. The amount of Zn in the ZnCuO sample is 5 wt % relative to a total weight of Zn and Cu in the ZnCuO nanoparticles.

### Example 3: Preparation of Working Electrode on a Gas Diffusion Layer (GDL)

mg of ZnCuO and 2 mg carbon were dispersed in 750 μL isopropanol, 200 μL DI H₂O, and 50 μL Nafion (5%) to obtain a suspension. The suspension was ultrasonicated for 20 minutes. 100 microliters (μL) of this ink was loaded on the top of the spray gun. The bottom of the spray gun was connected to an air cylinder to apply air pressure. The materials were sprayed on the GDL, dried at room temperature (RT), and dried in a vacuum oven at 60° C. The GDL was hydrophilic carbon paper (weakly hydrophobic).

### Example 4: Electrochemical Characterization Techniques

Linear sweep voltammetry (LSV) was conducted using a three-electrode electrochemical cell configuration with a potentiostat (Gammry 620) electrochemical workstation. A platinum (Pt) mesh and a silver/silver chloride (Ag/AgCl) (saturated with potassium chloride (KCl)) were used as the counter electrode and reference electrode, respectively. The working electrode employed in the experiment was a catalyst-coated drop cast onto a carbon paper substrate. The linear sweep voltammograms (LSVs) were obtained by conducting experiments in 0.5 molar (M) potassium bicarbonate (KHCO₃) aqueous solutions that were saturated with CO₂. The voltage range for the LSVs was from 0 V to −1.6 V against a reversible hydrogen electrode (RHE), and the scan rate used was 20 millivolts per second (mV s⁻¹). The potentials measured in relation to Ag/AgCl were transformed into RHE values using the equation,

E_{RHE}(V)=E_{Ag/AgCl}(V)+0.197V+(0.059 V×pH)

The experimental investigation involved the utilization of the chronoamperometric (CA) approach to conduct CO₂ electrolysis studies. The electrochemical studies were conducted using an H-type cell. The compartments containing the cathode and anode are effectively partitioned by a proton exchange membrane undergoing pretreatment. The flow cell configuration includes three main components. The initial component included a dual-compartment system designed to contain electrolytes. One of the compartments was designated for the catholyte, while the other was designated for the anolyte. Both compartments contained a solution of 1.0 M potassium hydroxide (KOH). The second constituent of the system is the cell, including a cathode section whereby CO₂ gas is directed through one side of a gas diffusion electrode (GDE), while the catholyte is directed through the opposite side. The anode compartment is linked to the anolyte. The cellular constituents are segregated by an anionic membrane. The pump, the third component of the flow cell, plays a role in enabling the movement and circulation of the catholyte and anolyte between the compartments that house the electrolytes within the cell. The reference electrode, like the hydrogen fuel cell (H-Cell), is connected to the working electrode (GDE) on the cathode side and the counter electrode on the anode side. All the components above are interconnected with the potentiostat workstation. An embodiment of such a flow cell is depicted in FIG. 7A.

### Example 5: Electrode Characterization

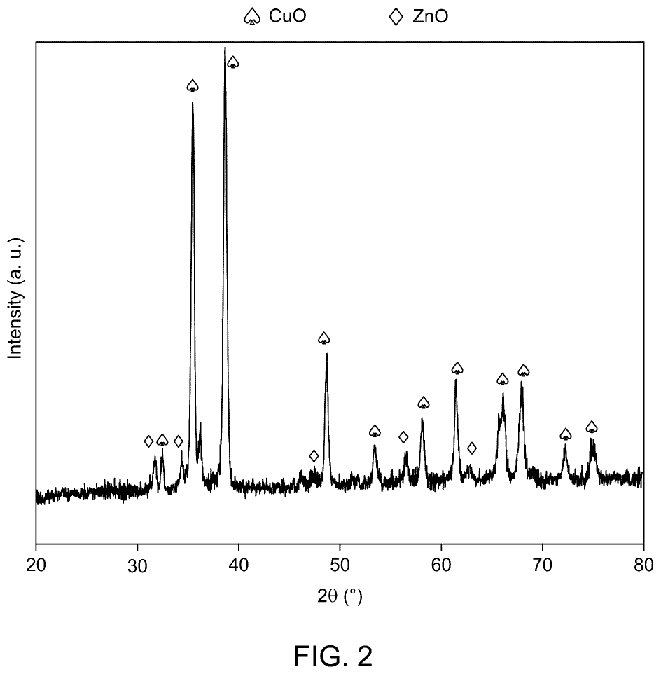

FIG. 2 illustrates a graph depicting the X-ray diffraction (XRD) analysis curve of ZnCuO. In FIG. 2, the ZnCuO sample obtained from HKUST-1 exhibited prominent peaks corresponding to CuO on the ZnO material. The observed peaks at 20 values of 35.4°, 38.6°, 48.5°, 58.0°, and 61.2° are attributed to the monoclinic CuO crystal structure, specifically the (−111), (111), (−202), (202), and (−113) facets, respectively. On the other hand, the peaks with lower intensities seen at values of 31.78°, 47.55°, 56.61°, and 67.87° are assigned to the hexagonal ZnO crystal structure, specifically the (100), (102), (110), and (112) facets, respectively.

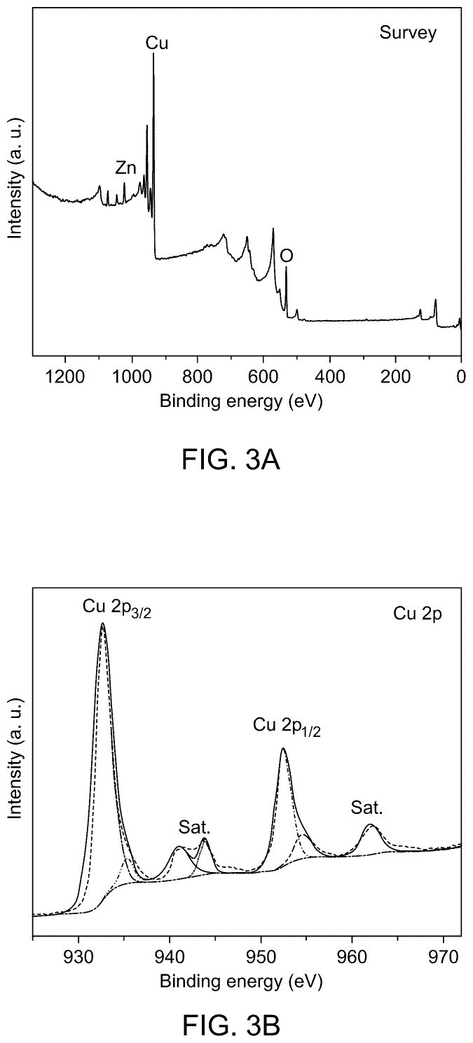

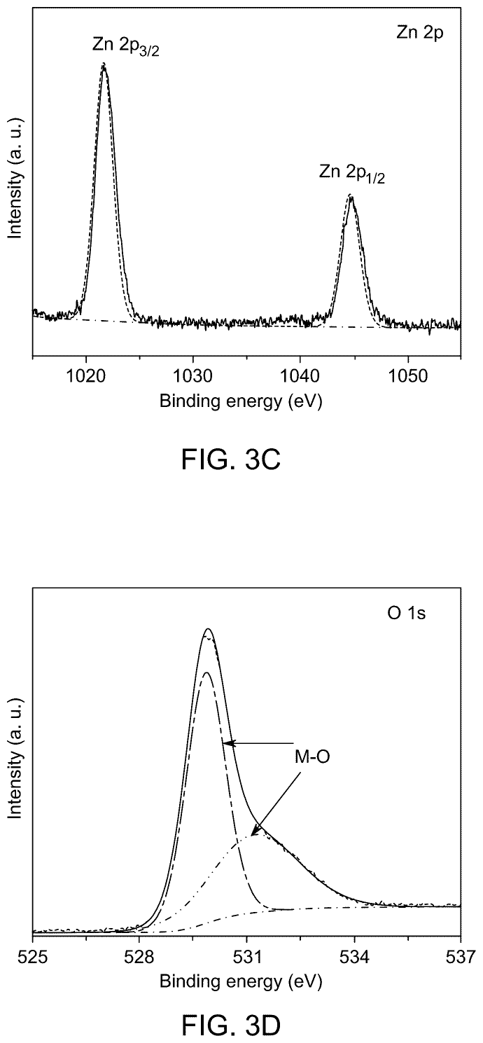

X-ray photoelectron spectroscopy (XPS) was utilized to investigate the valence states of a plurality of elements found in ZnCuO. FIG. 3A depicts the XPS survey of ZnCuO. As can be seen from FIG. 3A, the existence of copper (Cu), oxygen (O), and zinc (Zn) constituents was confirmed. The XPS spectra of Cu 2p, as depicted in FIG. 3B the spectrum can be partitioned into two constituents: Cu 2p_{1/2} and Cu 2p_{3/2}. Further, it is worth noting that three distinct satellite peaks have been detected, each corresponding to energy levels of 962.1 eV, 943.8 eV, and 941.1 eV, respectively. As can be seen from FIG. 3B, the Cu 2p_{1/2} signal is effectively characterized by two separate peaks at 955.5 eV and 952.6 eV, denoting the Cu²⁺ and Cu⁰ oxidation states, respectively. The Cu 2p_{3/2} signal is represented by two separate peaks at 935.4 eV and 933.2 eV, which correspond to the oxidation states of Cu²⁺ and Cu⁰, respectively. FIG. 3C depicts the spectra of Zn 2p. The spectra exhibit two distinct peaks at energy levels of 1044.7 eV and 1021.7 eV, indicating the existence of Zn²⁺ ions. FIG. 3D depicts the spectra of the O 1s. The O 1s orbital has a peak that is ascribed to two separate contributions. The peak observed at 531.1 eV is attributed to the existence of a hydroxyl group (M-OH), whereas the peak at 530.3 eV signifies the presence of a metallic oxide (M-O).

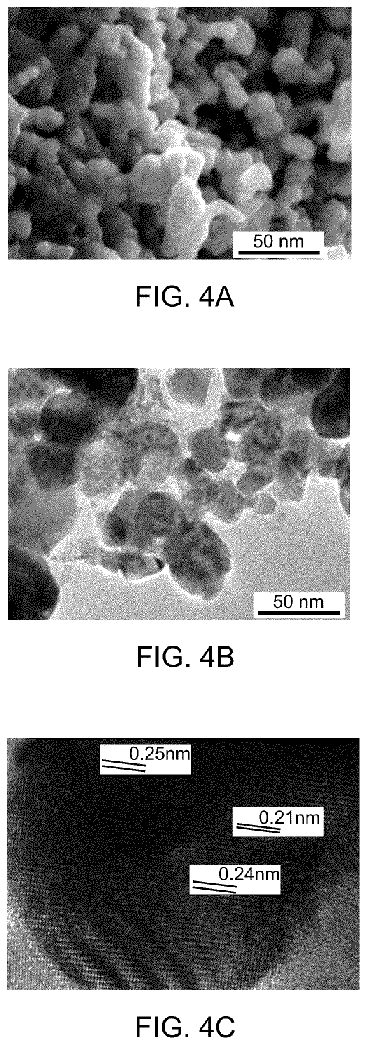

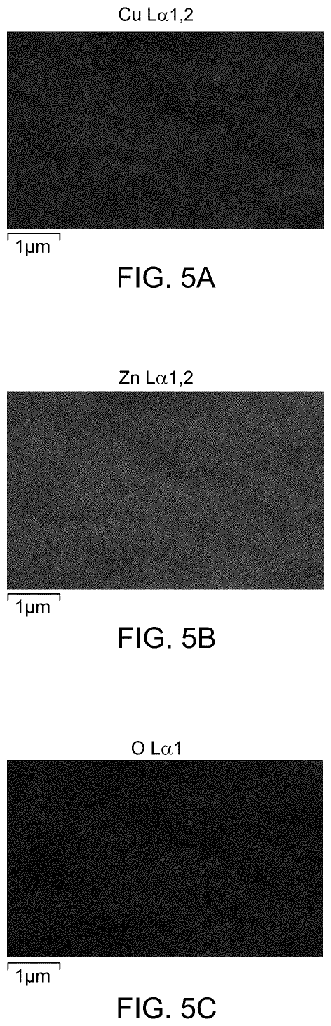

Scanning electron microscopy (SEM), transmission electron microscopy (TEM), and high-resolution transmission electron microscopy (HRTEM) were utilized to analyze the morphological structure, as shown in FIGS. 4A-4C, respectively. The scanning electron micrograph revealed that ZnCuO was composed of discrete semispherical nanoparticles with crystal sizes less than 100 nanometers (nm). The relatively tiny size of these crystals affects the electrochemical performance. As can be seen from FIG. 4B, the TEM has confirmed the creation of a morphology similar to a sphere. Further, as can be seen from FIG. 4C, the HRTEM reveals the fringe planes (interplanar distances) of ZnO and CuO. FIGS. 5A-5C depicts the results of the EDX analysis, confirming the presence of elements including copper, zinc, and oxygen, dispersed evenly.

### Example 6: Electrode Characterization

The investigation of the electrode, including ZnCuO, was extended to a flow cell configuration, in addition to an H-cell. The GDE-type electrolyzer improves CO₂ supply compared to the standard H-type electrolyzer. During the CO₂ electroreduction (CO₂ER) process, CO₂ molecules are conveyed from the gas chamber situated on one side of the working electrode (WE) to the catalyst layer through the GDL at the interface between the catalyst and the catholyte. The increase of CO₂ mass transfer efficiency and the elevation of CO₂ concentration on the surface of the electrode resulted in enhanced current density and electroreduction performance in the structural configuration of a GDE-type electrolyzer, particularly for industrial applications. Further, GDE electrolyzer(s) may achieve high current densities while preserving enhanced selectivity for diverse product outputs. The LSV and faradaic efficiency (FE) values obtained from the flow cell were compared to the corresponding results obtained from the H-cell.

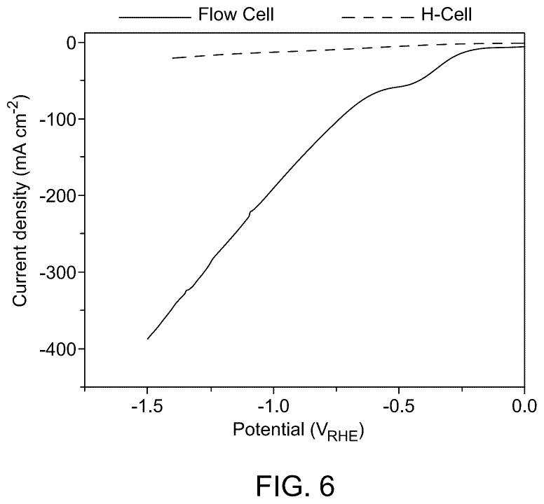

As depicted in FIG. 6, the current density in milliampere per square centimeter (mA cm⁻²) within the flow cell is notably greater than within the H-cell. This phenomenon is ascribed to the GDE, which facilitates the increased diffusion of CO₂ onto the surface of the catalyst. Furthermore, the flow system delivers a continuous supply of fresh electrolyte to the surface of the electrodes, enhancing the efficiency of the overall reaction. The trend of FE % exhibited variation in the context of the flow cell. FIG. 6 depicts a current density of 400 mA cm⁻² at 1.5 V_{RHE}, which is around twenty times higher than the current measured in the H-Cell scenario.

FIG. 7A displays a schematic representation of an experimental setup for the flow-cell and relevant components. As can be seen from FIG. 7B, an increase in CO₂ concentration in the vicinity of the catalyst surface resulted in an accelerated reduction reaction, leading to higher current density and improved CO₂ conversion rates. The hydrogen evolution reaction (HER) exhibited a notable suppression compared to the H-cell. The FE % of hydrogen (H₂) was measured at various potentials ranging from −0.7 V_{RHE} to −1.3 V_{RHE}. The reported FE % values for H₂ were 35%, 18%, 15%, 10%, 25%, 38%, and 45%. A single liquid product, namely formic acid, was seen at potentials of −0.7 V_{RHE} and −0.8 V_{RHE}, with corresponding Fe % of 20% and 16%. The concentration of carbon monoxide (CO) exhibited an increase, with the ability to potentially reach a FE % of 35% at −1.0 V vs the V_{RHE}. Subsequently, the concentration of CO remained rather steady at higher potentials. A similar pattern was seen for methane, where an FE % of 21% was calculated at a potential of −0.9 V_{RHE}. C₂H₄ was one of the primary substances evaluated in the flow cell experiment. The recorded FE % for C₂H₄ were 22%, 26%, 33%, 45%, 32%, 19%, and 15% within the range of −0.7 V_{RHE} to −1.3 V_{RHE}. The ZnCuO material exhibited a high FE % of 45% and a current density of 200 mA cm⁻², as depicted in FIG. 7C. The partial current density seen for C₂H₄ in the flow cell was greater, measuring 90 mA cm⁻², compared to the partial current density recorded for ethane in the H-Cell, which was 8.8 mA cm⁻². The investigation of long-term stability was conducted in the flow cell, where the current density and C₂H₄ FE % were recorded for 10 h. The catalyst demonstrated a consistent current throughout the reaction period, as depicted in FIG. 7D. Additionally, the generation of C₂H₄ remained stable in accordance with the current curve.

Numerous modifications and variations of the present disclosure are possible in light of the above teachings. It is therefore to be understood that within the scope of the appended claims, the invention may be practiced otherwise than as specifically described herein.

1. A method of making an electrode, comprising:
dissolving a copper salt and benzene-1,3,5-tricarboxylate in a solvent and heating to a temperature of 60-100° C. to form a framework;
mixing a zinc salt and the framework to form a zinc doped framework;
heating the zinc doped framework to a temperature of 300° C. to 600° C. under air to form ZnCuO nanoparticles;
mixing the ZnCuO nanoparticles, a binding compound, and a conductive carbon compound in a solvent to form a suspension; and
spraying the suspension onto a substrate with a spray gun using air pressure to form the electrode,
wherein the ZnCuO nanoparticles have a spherical shape with an average size of less than 100 nm.

2. The method of claim 1, wherein the ZnCuO nanoparticles have an average size of 10 nm to 60 nm.

3. The method of claim 1, wherein the ZnCuO nanoparticles comprise 5 wt % to 50 wt % Zn, relative to a total weight of Zn and Cu in the ZnCuO nanoparticles.

4. The method of claim 1, wherein the ZnCuO nanoparticles are aggregated forming an interconnected structure.

5. The method of claim 1, wherein the ZnCuO nanoparticles comprise CuO and ZnO and wherein the CuO has a monoclinic crystal structure and the ZnO has a hexagonal crystal structure.

6. The method of claim 5, wherein the CuO and ZnO are uniformly dispersed in the ZnCuO nanoparticles.

7. The method of claim 1, further comprising sonicating the suspension for at least minutes prior to the spraying.

8. The method of claim 1, wherein in the mixing of the zinc salt, Zn is homogeneously dispersed in pores of the framework without distortion of the framework.

9. The method of claim 1, wherein the heating is to about 500° C.

10. The method of claim 1, wherein the copper salt is selected from the group consisting of copper (II) chloride, copper (II) sulfate, copper (II) nitrate, copper (II) acetate, copper (II) bromide, and hydrates thereof.

11. The method of claim 1, wherein the zinc salt is selected from the group consisting of zinc (II) chloride, zinc (II) sulfate, zinc (II) nitrate, zinc (II) acetate, zinc (II) bromide, and hydrates thereof.

12. The method of claim 1, wherein the conductive carbon compound is at least one selected from the group consisting of graphite, activated carbon, reduced graphene oxide, carbon nanotubes, carbon nanofibers, and carbon black.

13. The method of claim 1, wherein the binding compound is a fluorinated polymer.

14. The method of claim 1, wherein the substrate is made from at least one material selected from the group consisting of conductive carbon, stainless steel, aluminum, nickel, copper, platinum, zinc, tungsten, and titanium.

15. The method of claim 1, wherein the suspension comprises 70 wt. % to 90 wt. % of the ZnCuO nanoparticles and 10 wt. % to 30 wt. % of the conductive carbon compound, based on a total weight of the ZnCuO nanoparticles and the conductive carbon compound.

16. The method of claim 1, further comprising:
applying a potential of −0.1 V to −2.0 V vs RHE to an electrochemical cell,
wherein the electrochemical cell is at least partially submerged in an aqueous solution comprising carbon dioxide,
wherein on applying the potential the carbon dioxide is reduced to a conversion product,
wherein the electrochemical cell comprises:
the electrode; and
a counter electrode.

17. The method of claim 16, wherein the conversion product is selected from ethylene, methane, formic acid, and carbon monoxide.

18. The method of claim 16, wherein the aqueous solution further comprises a base selected from at least one of sodium bicarbonate and potassium bicarbonate.

19. The method of claim 16, having a faradic efficiency for reducing carbon dioxide to ethylene of 40% to 50% at −1 V vs RHE.

20. The method of claim 1, wherein the substrate is a gas diffusion layer (GDL) and the electrochemical cell is in a flow cell configuration.
